(19) United States
(12) Patent Application Publication
(10) Pub. No.: US 2019/0168140 A1
(43) Pub. Date: Jun. 6, 2019

(54) APPLICATION BASED WATER DRAIN FEATURE FOR FUEL WATER SEPARATORS AND/OR NATURAL GAS FILTERS

(71) Applicant: Cummins Filtration IP, Inc., Columbus, IN (US)

(72) Inventors: Abhijeet Vaidya, Columbus, IN (US); Abhijit Shimpi, Hermitage, TN (US)

(73) Assignee: Cummins Filtration IP, Inc., Columbus, IN (US)

(21) Appl. No.: 16/321,331

(22) PCT Filed: Aug. 2, 2016
(86) PCT No.: PCT/US16/45175

§ 371 Date: Jan. 28, 2019

(51) Int. Cl. B01D 35/143; B01D 36/00; B01D 37/04; B01D 35/00; F02M 37/28

(52) U.S. Cl. CPC B01D 35/143; B01D 36/006; B01D 36/005; B01D 2201/56; B01D 35/005; F02M 37/28; B01D 2201/54; B01D 37/045

(57) ABSTRACT

Systems and methods to remotely drain a filter assembly includes a filter, an intelligent solenoid coupled to the filter, a controller communicatively coupled to the intelligent solenoid, the controller configured to: determine, via the filter management circuit, a filter state based, at least in part, on the determination of the fluid amount exceeding the predetermined threshold value, and a remote user device communicatively coupled to the intelligent solenoid, the remote user device configured to: connect, via a network configured for wireless connectivity, to the intelligent solenoid coupled to the filter, receive, from the intelligent solenoid, information corresponding to a filter state indicative of the fluid amount corresponding to the filter assembly, and transmit instructions to the intelligent solenoid configured to actuate the intelligent solenoid to thereby cause a release of fluid responsive to the filter state and the transmitted instructions.

### TECHNICAL FIELD

The present application relates generally to a filtration apparatus for filtering liquid fluids.

### BACKGROUND

Internal combustion (IC) engines use the energy produced by the combustion of fuels (e.g., diesel, gasoline, ethanol, natural gas, etc.) to perform mechanical work. Most fuels used by IC engines, for example, diesel, gasoline and ethanol, are in the liquid state when provided to the IC engines. Such fuels are typically filtered to remove contaminants such as, water, particulates, debris, dust, etc. before insertion into a combustion chamber of the IC engine.

To prevent or reduce the amount of contaminants being communicated to the IC engine, a filter is generally disposed upstream of the IC engine and fluidically coupled to the IC engine. The filter traps the contaminants as the fuel passes through the filter such that fuel which is substantially free from contaminants is inserted into the combustion chamber. The level of contaminants increases after repeated use and is therefore serviced or removed on a periodic basis. Additionally, it is also that undesirable fluids (e.g. water in fuel) can be mixed, potentially leading to the damaging vital engine parts if allowed to enter the system. For these reasons, filters such as fuel/natural gas filters are regularly drained to avoid such scenarios. Sensors/transducers are often provided to detect such conditions and to warn the operator of the necessity of a drain event

### SUMMARY

One implementation relates to a system for remotely draining a filter. The system includes a filter, an intelligent solenoid coupled to the filter, and a controller communicatively coupled to the intelligent solenoid. The controller is configured to determine, via the filter management circuit, a filter state based, at least in part, on the determination of the fluid amount exceeding the predetermined threshold value, and a remote user device communicatively coupled to the intelligent solenoid. The remote user device is configured to: connect, via a network configured for wireless connectivity, to the intelligent solenoid coupled to the filter, receive, from the intelligent solenoid, information corresponding to a filter state indicative of a fluid amount corresponding to the filter, and transmit instructions so as to actuate the intelligent solenoid to thereby cause a release of fluid responsive to the filter state and the transmitted instructions.

Another implementation relates to an apparatus including a controller. The controller is configured to: determine, via a filter management circuit, a predetermined threshold value corresponding to a filter assembly; determine, via the filter management circuit, whether a fluid amount in the filter assembly exceeds the predetermined threshold value; determine, via the filter management circuit, a filter state based, at least in part, on the determination of the fluid amount exceeding the predetermined threshold value; and provide, via the filter management circuit, information corresponding to the filter state to a remote user device.

Another implementation relates to a method for remotely draining a filter assembly. The method includes connecting, via a network configured for wireless connectivity, to an intelligent solenoid coupled to the filter assembly; receiving, from the intelligent solenoid, information corresponding to a filter state indicative of a fluid amount corresponding to the filter assembly; and transmitting instructions so as to actuate the intelligent solenoid to thereby cause a release of fluid responsive to the filter state and the transmitted instructions.

Another implementation relates to an apparatus including a remote user device. The remote user device is configured to: connect, via a network configured for wireless connectivity, to an intelligent solenoid coupled to a filter assembly; receive from the intelligent solenoid information corresponding to a filter state indicative of a fluid amount corresponding to the filter assembly; and transmit instructions so as to actuate the intelligent solenoid to thereby cause a release of fluid responsive to the filter state and the transmitted instructions.

These and other features of the implementations described herein, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a schematic block diagram of an example filtration system;

FIG. 2 is a schematic block diagram of an example controller for use in the filtration system of FIG. 1;

FIG. 3 is a schematic block diagram of an example remote user device usable the filtration system of FIG. 1;

FIG. 4 shows various views of a vehicle management interface included in a remote user device according to an example embodiment; and

FIG. 5 is a schematic flow diagram of an example method of remotely draining a filter.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

### I. Overview

Embodiments described herein relate generally to a filtration system for filtering liquid fuels, and in particular to a filtration system that includes an intelligent solenoid coupled to a filter and a remote user device communicatively coupled to the intelligent solenoid. In this regard, a remote user device may be configured to connect, via a network configured for wireless connectivity, to the intelligent solenoid. In turn, the remote user device may receive, via a vehicle management interface corresponding to the remote user device, information corresponding to a filter state indicative of a fluid amount corresponding to the filter. The remote user device may then cause a release of fluid (e.g., contaminants such as water) responsive to the filter state.

### II. Overview of Filtration System

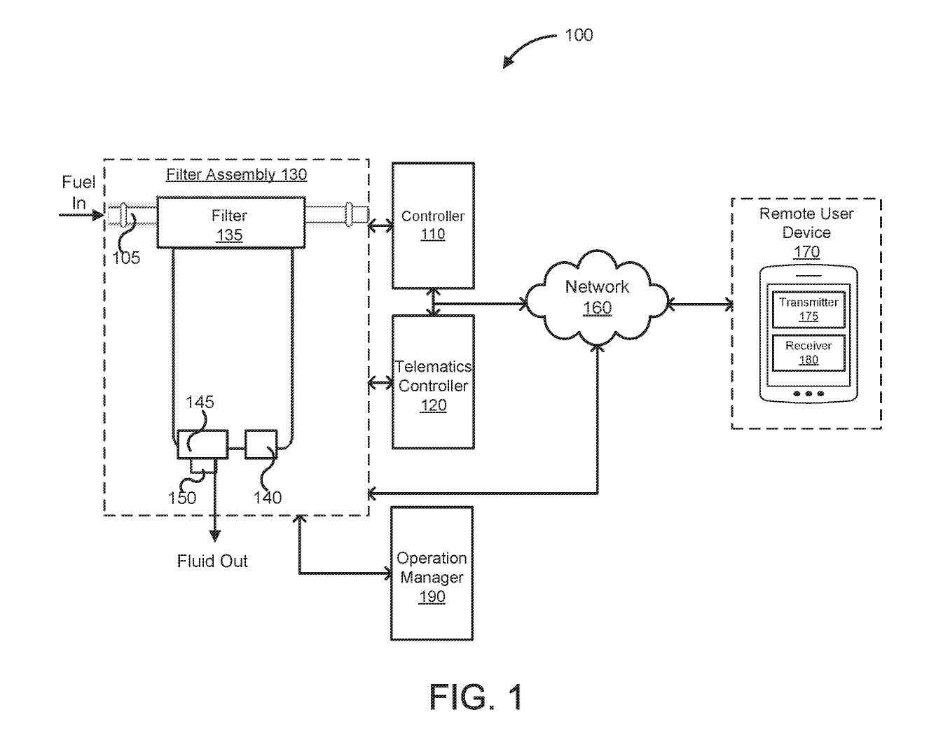

With reference to FIG. 1, a filtration system 100 is illustrated. The filtration system 100 may be associated with an on-road vehicle or an off-road vehicle including, but not limited to, cars, trucks, boats, vans, airplanes, or any other type of vehicle. In this example embodiment, the filtration system 100 includes a controller 110, telematics controller 120, a filter assembly 130, network 160, a remote device 170 (e.g., a remote user device), and an operations manager 190. The filter assembly 130 includes a filter element 135 (e.g., a fuel water separator, natural gas filter, etc.), a sensor 140 (e.g., a water-in-fuel sensor), intelligent solenoid 145, and a release (e.g., a valve) 150. The filter assembly 130 can be moved between a first configuration and a second configuration to selectively release a fluid (e.g., fuel contaminated with water, particulates, debris, dust, etc.) from the filter assembly 130. The fluid may be released before uncoupling the filter assembly 130 from an internal combustion (IC) engine. It should be understood that the filtration system 100 may include additional, less, and/or different components/systems than depicted in FIG. 1, such that the principles, methods, systems, apparatuses, processes, and the like of the present disclosure are intended to be applicable with any other filtration system configuration.

Portions of the filter element 135 (e.g., the end caps thereof) may be made from a strong and rigid material such as, for example, high density polypropylene (HDPP). The housing defines an internal cavity sized to receive fluids and/or contaminants.

The filter assembly 130 includes an inlet 105 for receiving fluid (e.g., diesel fuel, gasoline, ethanol, etc.), for example, from a fluid tank. The fluid received from the fluid tank can be contaminated with contaminants such as water, particulates, debris, dust, etc. The fluid passes through the filter element 135 to remove contaminants from the fluid. The clean fluid then passes to the IC engine. The filter assembly 130 also includes a release 150, such as a valve, for expelling the fluid (e.g., water) which remains within the internal cavity of filter assembly 130.

The filter assembly 130 also includes an intelligent solenoid 145. As used herein, the term “intelligent solenoid” refers to a solenoid configured to selectively drain contaminants from a filter such as a fuel water separator, natural gas filter, etc. The intelligent solenoid (e.g., the intelligent solenoid 145) is further configured to operate wirelessly via a wireless chip, wireless circuit, wireless communication network (e.g., the network 160), protocol, standard, or combinations thereof, such as a cellular network, WiFi, Bluetooth®, local area network (LAN), wide area network (WAN), etc. Accordingly, the intelligent solenoid 145 may be communicatively coupled, via the network 160, to a remote user device (e.g., the remote device 170) as described herein. In embodiments in which the intelligent solenoid includes a wireless circuit, the wireless circuit may be energized via at least one of a control circuit, battery, or radio frequency circuit.

The filtration system 100 also includes a remote device 170 communicatively coupled to the intelligent solenoid 145. As used herein, the term “remote user device” refers to an electronic device, such as a mobile telephone, smartphone, wearable, personal digital assistant (PDA), tablet computer, laptop computer, or other computing device configured to access one or more programs, servers, networks, central computers, etc. The interface of the remote user device with the intelligent solenoid 145 may operate via the network 160, such as via any of a wide variety of communication techniques including wireless communications, such as cellular communications, wide area networks (WAN), local area networks (LAN) or position-based communications, such as Bluetooth, Wi-Fi, or other position-based communications techniques. The remote device 170 includes a transmitter 175 configured to generate radio frequency transmissions. The transmitter 175 may be configured for Bluetooth® or other transmission protocols. The remote device 170 further includes a receiver 180 configured to receive radio frequency transmissions. In some embodiments, the transmitter 175 and the receiver 180 may take the form of a transceiver configured to send and receive radio frequency transmissions.

The filtration system 100 is also shown to include a telematics controller 120. The telematics controller 120 may be structured as any type of telematics control unit or circuitry. Accordingly, the telematics controller 120 may include, but is not limited to, a location positioning system (e.g., global positioning system) to track the location of a vehicle (e.g., latitude and longitude data, elevation data, etc.), one or more memory devices for storing the tracked data, one or more electronic processing units for processing the tracked data, and a communications interface for facilitating the exchange of data between the telematics controller 120 and one or more remote user devices (e.g., a provider/manufacturer of the telematics device, etc.). In this regard, the communications interface may be structured as any type of mobile communications interface or protocol including, but not limited to, Wi-Fi, WiMax, Internet, Radio, Bluetooth®, Zigbee, satellite, radio, cellular, GSM, GPRS, LTE, etc.

The telematics controller 120 may also include a communications interface for communicating with the controller 110 of the filtration system 100. The communication interface for communicating with the controller 110 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information, and/or data between the controller 110 and the telematics controller 120. In other embodiments, a local area network (LAN), a wide area network (WAN), or an external computer (for example, through the Internet using an Internet Service Provider) may provide, facilitate, and support communication between the telematics controller 120 and the controller 110. In still another embodiment, the communication between the telematics controller 120 and the controller 110 is via the unified diagnostic services (UDS) protocol. All such variations are intended to fall within the spirit and scope of the present disclosure

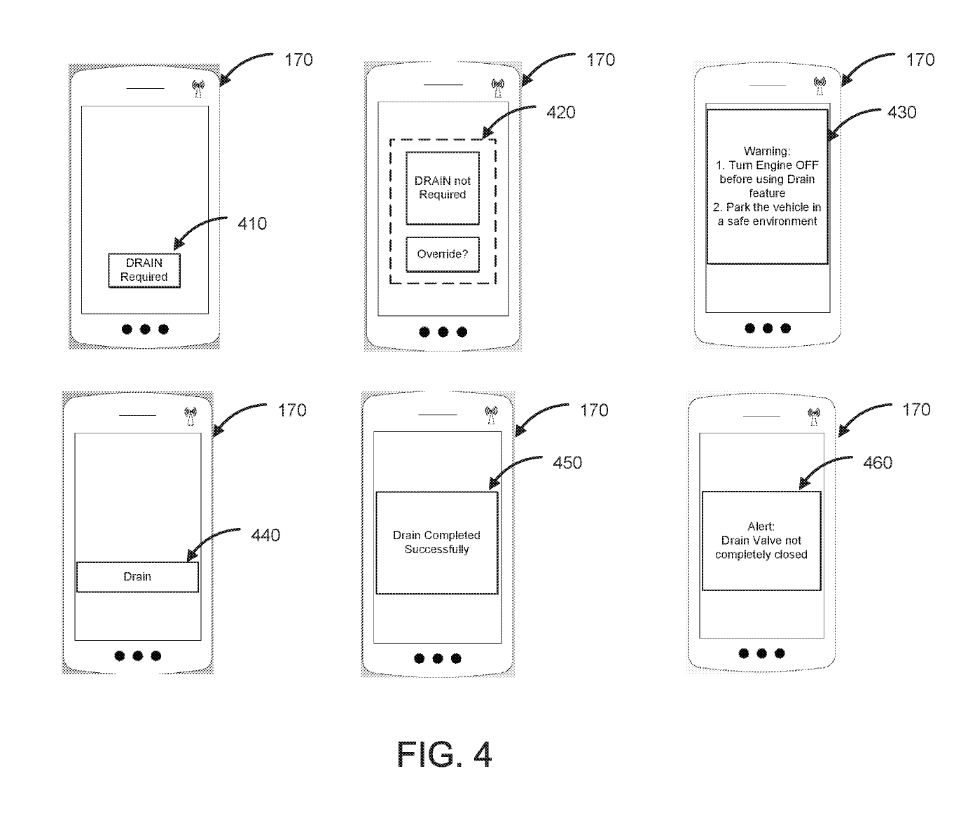

The filter assembly 130 also includes the controller 120 configured to perform certain operations, such as those described herein in relation to FIG. 4. In certain embodiments, the controller 120 forms a portion of a processing subsystem including one or more computing devices having memory, processing, and communication hardware. The controller 120 may include a microprocessor, an application-specific integrated circuit (ASIC), a field-programmable gate array (FPGA), etc., or combinations thereof. The controller 120 may include memory which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller 120 can read instructions. The instructions may include code from any suitable programming language. The controller 120 may be a single device or a distributed device, and the functions of the controller 120 may be performed by hardware and/or as computer instructions on a non-transient computer readable storage medium.

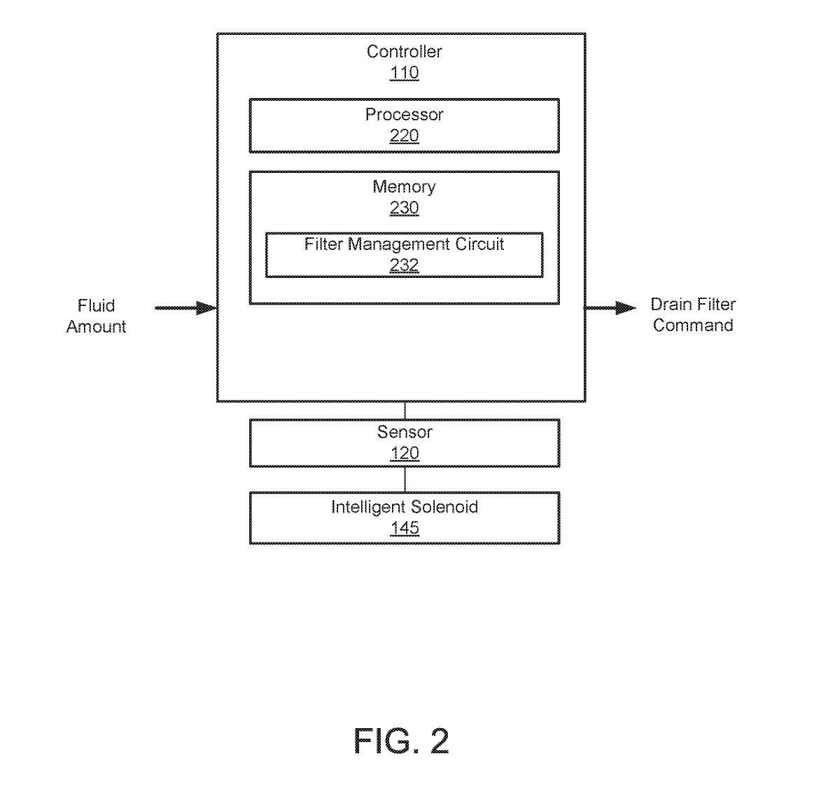

In certain embodiments, the controller 120 includes or is otherwise in communication with circuitry configured to functionally execute the operations of the controller 120. In further embodiments, the controller 120 may include a filter management circuit for performing the operations described in reference to FIG. 4. The description herein relating to circuits emphasizes the structural independence of the aspects of the controller 120 and illustrates one grouping of operations and responsibilities of the controller 120. Other groupings that execute similar overall operations are understood within the scope of the present application. A circuit may be implemented in hardware and/or as computer instructions on a non-transient computer readable storage medium, and such circuits may be distributed across various hardware or computer based components. More specific descriptions of certain embodiments of controller operations are included in the section referencing FIGS. 2-5.

The filter assembly 130 also includes a sensor 140 coupled to the filter element 135. The sensor 140 is configured to determine the fluid amount corresponding to the filter assembly 130. The fluid amount can be determined by measuring the fluid level in the filter assembly 130. For example, the sensor 140 is configured to determine the amount of water (e.g., measure the level of water) in the internal cavity of the filter assembly 130. The fluid amount determined may be provided by the sensor 140 to the controller 110. Alternatively or additionally, the fluid amount determined may be otherwise retrieved by the controller 110 and/or the operations manager 190.

Example and non-limiting circuit implementation elements include sensors (e.g., the sensor 140) providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the circuit specification, any actuator including at least an electrical, hydraulic, or pneumatic actuator, a solenoid, an op-amp, analog control elements (springs, filters, integrators, adders, dividers, gain elements), and/or digital control elements.

### III. Example Configurations for the Filtration System

FIG. 2 is a schematic block diagram of an example controller 110 usable with the filtration system 100. The controller 110 may be communicatively coupled to a filter assembly (e.g. the filter assembly 130). In this particular embodiment, the controller 110 includes a processor 220, a memory 230 or other computer readable medium. It should be understood that the controller 110 of FIG. 2 depicts only one embodiment of the controller 110, and any other controller capable of performing the operations described herein can be used.

The processor 220 can include a microprocessor, programmable logic controller (PLC) chip, an ASIC chip, or any other suitable processor. The processor 220 is in communication with the memory 230 and configured to execute instructions, algorithms, commands or otherwise programs stored in the memory 230.

The memory 230 includes any of the memory and/or storage components discussed herein. For example, the memory 230 may include RAM and/or cache of the processor 220. The memory 230 may also include one or more storage devices (e.g., hard drives, flash drives, computer readable media, etc.) either local or remote to the controller 110. The memory 230 is configured to store look up tables, algorithms, or instructions.

The controller 110 is communicatively coupled to the operations manager 190 (e.g., an on-board diagnostics system configured to determine the status of the various components, elements, or systems of the vehicle). The operations manager 190 includes a processor, memory or other computer readable medium similar to or otherwise like the processor, memory, or other computer readable medium as described herein with reference to the controller 110. The description of the processor, memory, or other computer readable medium with respect to the operations manager 190 is not included for the sake of brevity. Further, it should be understood that the operations manager 190 may be included in a vehicle associated with the filtration system 100, included within the remote device 170 described herein, or a combination thereof. In embodiments in which the operations manager 190 is included within the remote device 170, the operations manager 190 may communicate, via a network configured for wireless communication, with the controller 110 and/or the filter assembly 130.

The operations manager 190 is configured to determine whether the vehicle associated with the operations manager 190 is in an engine on state (e.g., an engine state indicative that the key is on and/or the engine is not shut down). If the operations manager 190 determines the vehicle is in an engine on state, the operations manager 190 determines a sensor operation state. For example, the operations manager 190 determines whether the sensor 140 (e.g., a water-in-fuel sensor) is operating properly such that the sensor 140 indicates the presence of water in the fuel. In the event that the sensor 140 is not functioning properly, the operations manager 190 generates an operation code (e.g., a fault code that indicates the sensor is not operating properly). If the sensor 140 is functioning properly, the operations manager 190 determines whether the connection associated with the controller 110 is operating properly such that the controller 110 receives, via the sensor 140, an electrical signal when the fluid amount (e.g., water level) in the filter assembly 130 reaches a predetermined threshold value.

In further embodiments, the operations manager 190 determines whether the intelligent solenoid 145 is operating properly such that the intelligent solenoid 145 is operable to actuate (e.g., opens) and/or terminate (e.g., close) the release (e.g., the valve), thereby, releasing fluid from the filter and/or preventing fluid flow. In the event that the connection corresponding to the controller 110 and/or the intelligent solenoid 145 is not functioning properly, the operations manager 190 generates an operation code (e.g., a fault code that indicates the connection corresponding to the controller 110 and/or the intelligent solenoid 145 is not operating properly). If the operations manager 190 determines the vehicle is in an engine off state (e.g., an engine state indicative that the key is not on and/or the engine is shut down), determines that the connection corresponding to the controller 110 and/or the intelligent solenoid 145 is operating properly, or a combination thereof, the operations manager 190 provides the fluid amount corresponding to the filter element to the controller 110. Alternatively or additionally, the controller 110 retrieves the fluid amount from the sensor 140, the operations manager 190, and/or memory.

The controller 110 includes a filter management circuit 232. The filter management circuit 232 is configured to determine a predetermined threshold value corresponding to the filter assembly 130. The predetermined threshold value includes the minimum value at which the filter assembly 130 is drained based on the fluid amount. A predetermined threshold value may be in the range of a calibrateable floor to a calibrateable ceiling. In particular embodiments, the predetermined threshold is calculated in cc/ml (for example, 75 ml). In typical implementations, the sensor's probe (which may be resistive, capacitive, or impedance based) is located in a suitable position to sense the water level or the other undesirable fluid level. As will be appreciated by one of ordinary skill in the art, the range corresponding to the predetermined threshold value (e.g., the calibrateable floor to the calibrateable ceiling) may vary based, at least in part, on the respective filter architecture for operability according to various conditions. For values outside of the range corresponding to the predetermined threshold value, in some example embodiments, a filter state (e.g., a fault code corresponding to a filtration system that indicates whether fluid is to be released from a filter) may be generated as described herein.

In particular embodiments, if an unqualified filter element (e.g., a filter element that is not compatible with the broader filter assembly 130 or has not otherwise been validated for use with the broader filter assembly 130), rather than determining a predetermined threshold, an error message or other indication may be provided notifying the user of the improper filter element. This information may also be provided to the remote device 170.

The filter management circuit 232 is further configured to determine whether the fluid amount in a filter assembly exceeds the predetermined threshold value. As described above, the sensor 140 is configured to determine the fluid amount corresponding to the filter element. The filter management circuit 232, in turn, utilizes the fluid amount indicated by the sensor 140 to determine whether the fluid amount in a filter assembly exceeds the predetermined threshold value. The filter management circuit 232 may be further configured to determine a filter state based, at least in part, on the determination of the fluid amount meeting and/or exceeding the predetermined threshold value for a given fluid amount which may be calibrated based, at least in part, on the respective engine architecture and/or filter. For example, if the filter management circuit 232 determines that the fluid amount in a filter element (e.g., an internal cavity) exceeds the predetermined threshold value, the filter state corresponding to a raised fault code is generated. The raised fault code indicates that a filter drain is required. If the filter management circuit 232 determines that the fluid amount does not meet the predetermined threshold value, the filter state corresponding to a low fault code is generated. The low fault code indicates that a filter drain is not required.

The filter management circuit 232 is further configured to provide information corresponding to the filter state. The filter management circuit 232 may provide the information to the remote device 170 via the network 160 (e.g., via a network configured for wireless communication such as WiFi). In some embodiments, the filter management circuit 232 may provide information corresponding to the filter state to the intelligent solenoid 145. The intelligent solenoid 145 may transmit, via the network 160 (e.g., via a chip or circuitry configured for paired communication such as Bluetooth) information corresponding to the filter state to the remote device 170. In further embodiments, the filter management circuit 232 may provide information corresponding to the filter state to the telematics controller 120. In turn, the telematics controller 120 may provide information corresponding to the filter state to the remote device 170 via the network 160 (e.g., a location positioning system such as GPS) and/or via the intelligent solenoid 145.

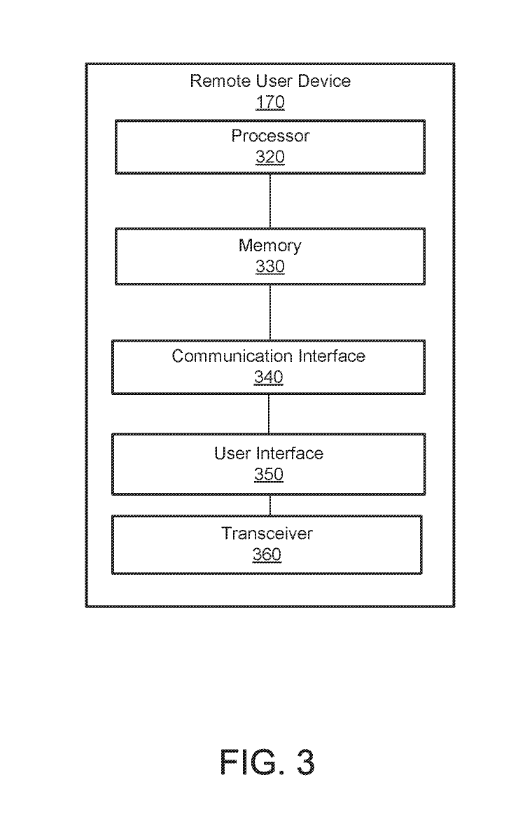

In some embodiments, the remote device 170 or any other remote user device may be communicably coupled to the intelligent solenoid 145 to remotely drain the filter assembly 130. For example, FIG. 3 is a block diagram of a remote device 170 in accordance with an illustrative embodiment. The remote device 170 can be used to perform any of the methods or the processes described herein, for example the method 500. As illustrated, the remote user device includes, is associated with or otherwise in communication with a processor 320, memory 330, communication interface 340, and user interface 350. In some embodiments, the controllers 110, 120 can be communicably coupled to the remote device 170. The one or more processors 320 or processing circuits may be coupled to a bus (not shown) for processing information. The remote device 170 can include the bus or other communication component or circuits for communicating information.

The remote device 170 also includes the memory 330, such as a random access memory (RAM) or other dynamic storage device for storing information and instructions to be executed by the processor 320. The memory 330 can also be used for storing filter data, position data, temporary data, or other intermediate information during execution of instructions by the processor 320. The memory 330 may further include read only memory (ROM) or other static storage device for storing static information and instructions for the processor 320.

The remote device 170 may include a communication interface 340 that may take the form of a device or circuitry embodied in either hardware, software, or a combination of hardware and software that is configured to receive and/or transmit data from or to the intelligent solenoid 145, controller 110, telematics controller 120, etc. The communication interface 340 may include an antenna (or multiple antennas) supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication.

The remote device 170 includes or is otherwise communicatively coupled to the user interface 350. The user interface 350 may include a mobile application, web user interface, display (e.g., a touch screen and/or display such as a liquid crystal display, or active matrix display), keyboard or alphanumeric pad, mouse, joystick or other input/output circuitry for communicating information and command selections to the processor 320. The user interface 350, such as a display, speakers, etc. may be configured to provide information to a user. In this example embodiment, the processor 320 may include user interface circuitry configured to control at least some functions of one or more input/output mechanisms. The processor 320 and/or user interface circuitry comprising the processor may be configured to control one or more functions of one or more input/output circuits through computer program instructions (for example, software and/or firmware) stored on a memory accessible to the processor (for example, the memory 230, etc.).

The remote device 170 is configured to connect, via a network configured for wireless connectivity, to the intelligent solenoid 145. The remote device 170 is communicatively coupled to the intelligent solenoid 145, telematics controller 120, location positioning system (e.g., global positioning system), or a combination thereof. Responsive to the remote device 170 connecting to the intelligent solenoid 145, the remote device 170 may be operable to associate or is otherwise configured to communicate (e.g., by the pairing of the intelligent solenoid 145 and the remote device 170 via a network configured for wireless connectivity) with the intelligent solenoid 145. Alternatively or additionally, the intelligent solenoid 145 is further configured to establish a connection with the remote device 170 such that the intelligent solenoid 145 may communicate with the remote device 170.

The remote device 170 may be configured to receive information corresponding to a filter state indicative of a fluid amount (e.g., a level or an amount of water) corresponding to the filter assembly 130. As used herein, the term “filter state” refers to a state which is based upon information from a sensor (e.g., the sensor 140) and relates to whether the filter is in need of a release of fluid (e.g., water). The filter state may be based on a determined fluid amount corresponding to the filter as indicated by the sensor 140. In further embodiments, the filter state may be based, at least in part, on information corresponding to a filter state provided via the filter management circuit 232 (e.g., circuitry configured to generate a fault code or otherwise manage the controller operations) as described herein below. The remote device 170 may receive information corresponding to the filter state information provided by the controller 110 via the network 160 (e.g., via a network configured for wireless communication such as WiFi). In some embodiments, the remote device 170 may receive information corresponding to the filter state provided by the intelligent solenoid 145. The intelligent solenoid 145 may transmit, via the network 160 (e.g., via a chip or circuitry configured for paired communication such as Bluetooth) the information corresponding to the filter state to the remote device 170. In further embodiments, the remote device 170 may receive information corresponding to the filter state provided by the telematics controller 120.

In some embodiments, the information corresponding to the filter state may be communicated to a user or operator of the remote device 170 via a vehicle management interface (e.g., a user interface 350 or mobile application configured to manage one or more vehicles, such as a fleet of vehicles) corresponding to the remote device 170. For example, the remote device 170 may output (e.g., display) information corresponding to the filter state via the vehicle management interface as illustrated in FIG. 3. The vehicle management interface may be operable when a vehicle associated with the filter assembly 130 is in an engine off state (e.g., a state indicative that the key is off and/or the engine is shut down). Alternatively or additionally, the vehicle management interface is inoperable when the vehicle is in an engine on state (e.g., a state indicative that the key is on and/or the engine is not shut down).

In some embodiments, information corresponding to the engine state, filter state, and/or a filter status notification (e.g., a digital notification such as an in-app notification, email notification, short message service message, audio message, alert, video, streaming content, etc.) is provided to communicate the status of the engine and/or the filter assembly 130 to a user or operator of the remote device 170. For example, the remote device 170 may receive information corresponding to the engine state (e.g., a code that indicates whether the key is on and/or whether the engine is shut down) provided by the operations manager 190 and/or the controller 110. The remote device 170 may be further configured to receive information such as various metrics, parameters, etc. associated with the fluid in the filter assembly in addition to the filter amount.

The remote device 170 may be configured to determine whether a vehicle associated with the filter is in an engine on state or an engine off state. If the engine state received indicates the key is on, the remote device 170 sets the engine state to engine on. If the information corresponding to the engine state received indicates the key is off, the remote device 170 sets the engine state to engine off. In turn, the remote device 170 may generate a filter status notification (e.g., an in-app message such as the filter status notification 430 described herein below) when the vehicle associated with the filter is in the engine on state or the engine off state based on the engine state received.

The filter state 410 may be output (e.g., displayed) via the vehicle management interface (e.g., the mobile application) to indicate that a filter drain is required. The filter state may be output via the vehicle management interface to indicate that a filter drain is not required. The vehicle management interface may be configured to indicate that the filter assembly 130 may be drained as illustrated in the filter state 440. In some embodiments, the vehicle management interface may be configured to indicate that the filter assembly 130 may be drained though the drain is not required. The filter status notification 430 may be output via the vehicle management interface when the vehicle is in the engine on state to indicate to the user or otherwise warn the operator of the remote device 170 that the key is on and/or the engine is not shut down.

In further embodiments, the remote device 170 may be configured to receive a vehicle management history. The vehicle management history may be retrieved from the memory 330 or otherwise received, via the remote device 170, from a database or memory (e.g., the memory 230 described in FIG. 2) corresponding to the controller 110 and/or the filtration system 100. The vehicle management history may be used as a basis to identify past maintenance performed, maintenance trends, etc. Alternatively or additionally, the vehicle maintenance history may be used to predict or otherwise determine maintenance needs. In turn, the remote device 170 may be further configured to provide the vehicle management history to an operator of the remote device 170. The vehicle management history may be provided (e.g., output, displayed, or otherwise communicated) by the remote device 170 via the user interface 350 (e.g., the vehicle management interface).

The remote device 170 is further configured to cause a release of fluid responsive to the filter state. The release of fluid may be caused in response to the remote device 170 receiving an indication (e.g., a user selection of a link, an icon, a button, an audio selection, etc.), configured to cause the release of the fluid from the filter assembly 130. For example, the remote device 170 may receive an indication to drain the filter in response to the filter state corresponding to a required filter drain. In some examples, the remote device 170 may receive an indication configured to cause a release of fluid responsive the selection of the “Drain Required” button 450. Alternatively or additionally, the remote device 170 may receive an indication to drain the filter in response to the filter state corresponding to an optional filter drain. For example, the remote device 170 may receive an indication configured to cause a release of fluid responsive the selection of the “Drain” button 450 and/or the “Override?” button 420.

Responsive to receiving the indication to release the fluid, the remote device 170 transmits, via the network configured for wireless connectivity (e.g., network 160), instructions to the intelligent solenoid 145 and/or the controller 110. The transmitted instructions are configured to actuate the intelligent solenoid 145. In turn, the intelligent solenoid 145 actuates (e.g., opens) the release 150 (e.g., the valve) corresponding to the intelligent solenoid 145. The intelligent solenoid 145 converts electrical energy into mechanical energy to actuate the release 150. As voltage is applied to the coil (not shown) of the intelligent solenoid 145, an electromagnetic field forms, which pushes a plunger (not shown) located within a core defined by the intelligent solenoid 145 in a predetermined direction (e.g., upwards) in the coil. The plunger which is mechanically coupled to the release 150 causes the release 150 to open. In one particular embodiment, the remote device 170 transmits the instructions directly to the intelligent solenoid. In an alternative embodiment, the instructions may be sent by the remote device 170 to the controller 110, which in turn instructs the intelligent solenoid accordingly.

In some embodiments, the release of fluid (e.g., the release of water) may occur according to a predetermined time based on the fluid amount (e.g., the water level). To that end, the intelligent solenoid 145 may be configured to operate between an on-position and an off-position. In some embodiments, the intelligent solenoid 145 may operate between the on-position and the off-position according to a predetermined time T such that the release of fluid occurs during the predetermined time T. For example, the intelligent solenoid 145 may be operable in the on-state to release fluid for a predetermined time T. At the expiration of the predetermined time T, the intelligent solenoid 145 moves to the off-state such that the release of fluid no longer occurs or is otherwise stopped.

The remote device 170 is further configured to receive the filter status notification 450 which may be output via the vehicle management interface to indicate whether the drain completed successfully. In alternative or additional embodiments, the filter status notification 460 or other respective filter status notifications may be output via the vehicle management interface to indicate whether the intelligent solenoid 145 moved between the on-position and the off-position, the release 150 is functioning properly (e.g., to indicate whether the valve closed completely, opened completely, etc.), etc.

According to various implementations, the processes and methods described herein can be implemented by the remote device 170 in response to the processor 320 executing an arrangement of instructions contained in the memory 330 (e.g., the operations of the method 500). Such instructions can be read into the memory 330 from another non-transitory computer-readable medium, such as the storage device. Execution of the arrangement of instructions contained in the memory 330 causes the remote device 170 to perform the illustrative processes described herein. One or more processors in a multi-processing arrangement may also be employed to execute the instructions contained in the memory 330. In alternative implementations, a hard-wired circuit may be used in place of or in combination with software instructions to effect illustrative implementations. Thus, implementations are not limited to any specific combination of hardware circuit and software.

Although an example remote user device (e.g., the remote device 170) has been described in FIG. 3, embodiments described in this specification can be implemented in other types of digital electronic circuit, or in computer software embodied on a tangible medium, firmware, or hardware, including the structures disclosed in this specification and their structural equivalents, or in combinations of one or more of them.

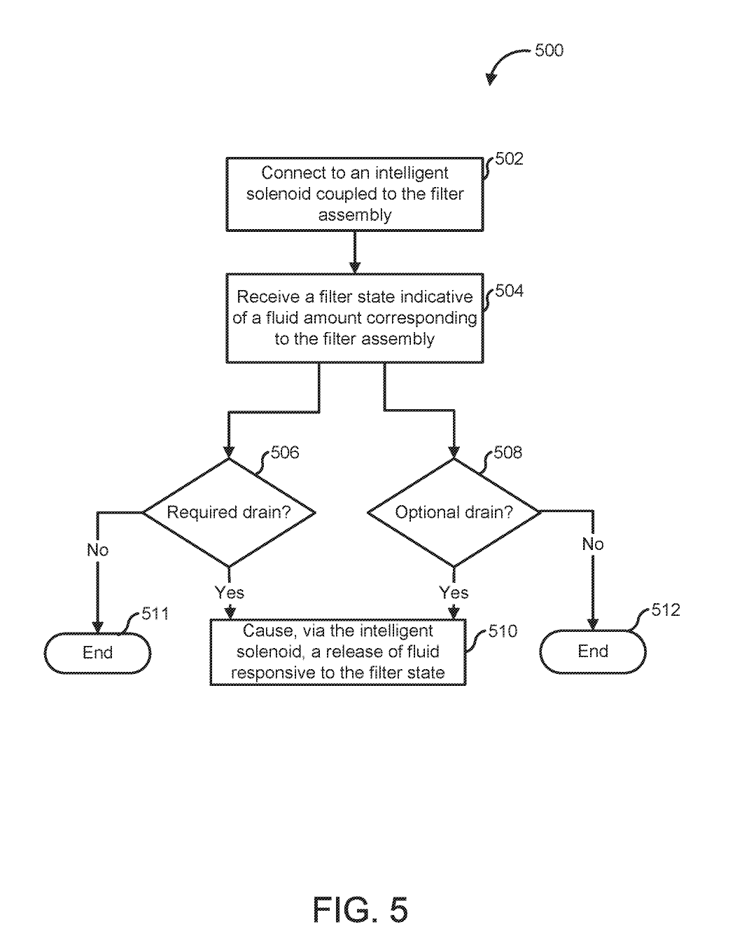

FIG. 5 is a flow diagram of an example process 500 for a remote device 170 to remotely drain a filter corresponding to a filtration system via the circuitry described herein with reference to FIGS. 1, 3, and 4. At 502, the process 500 includes connecting to an intelligent solenoid coupled to a filter. Responsive to the connection of the intelligent solenoid and remote user device, the remote user device may be operable to associate or is otherwise configured to communicate with the intelligent solenoid. For example, the remote user device may be paired with the intelligent solenoid via a network configured for wireless connectivity such as Bluetooth such that the intelligent solenoid may communicate or otherwise transmit signals to and/or receive signals from the filter.

At 504 information corresponding to a filter state indicative of a fluid amount corresponding to a filter element may be received by the remote user device. The remote user device may receive information corresponding to the filter state provided by the controller via the network (e.g., via a network configured for wireless communication such as WiFi). In some embodiments, the remote user device may receive information corresponding to the filter state provided by the intelligent solenoid. In this regard, the intelligent solenoid may transmit, via a chip or circuitry configured for paired communication, information corresponding to the filter state to the remote user device. The filter state may be communicated to a user or operator of the remote user device via a vehicle management interface (e.g., a user interface or mobile application configured to manage one or more vehicles, such as a fleet of vehicles) corresponding to the remote user device.

At 506, the remote user device may receive an indication to drain the filter in response to the filter state corresponding to a required filter drain. If the filter drain is required, the remote user device may receive an indication configured to cause a release of fluid as described below at 510. If the drain is not required, the process may end at 511. At 508, the remote user device may receive an indication to drain the filter in response to the filter state corresponding to an optional filter drain (e.g., a drain of the filter that may be performed though a predetermined threshold value has not been met and/or exceeded). If the remote device receives the indication corresponding to an optional filter drain, a release of fluid is caused as described below at 510. If the remote device does not receive the indication corresponding to an optional filter drain, the process may end at 512.

At 510, a release of fluid may be caused by the remote user device. The release of fluid may be caused in response to the remote user device receiving an indication (e.g., a selection) via a link, an icon, a button, an audio selection, etc., configured to cause the release of the fluid from the filter. Responsive to receiving the indication to release the fluid, the remote user device transmits, via the network, instructions to the intelligent solenoid and/or the controller to actuate the intelligent solenoid. In turn, the intelligent solenoid actuates (e.g., opens) the release (e.g., the valve), thereby, releasing the fluid from the filter.

The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as circuits, in order to more particularly emphasize their implementation independence. For example, a circuit may be implemented as a hardware circuit comprising custom VLSI circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

Circuits may also be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit.

Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network. Where a circuit or portions of a circuit are implemented in machine-readable medium (or computer-readable medium), the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. An apparatus comprising:
a controller, the controller configured to:
determine, via a filter management circuit, a predetermined threshold value corresponding to a filter assembly comprising an intelligent solenoid;
determine, via the filter management circuit, whether a fluid amount in the filter assembly exceeds the predetermined threshold value;
determine, via the filter management circuit, a filter state based, at least in part, on the determination of the fluid amount exceeding the predetermined threshold value; and
provide, via the filter management circuit, information corresponding to the filter state to a remote user device, wherein the intelligent solenoid is configured for actuation based on instructions wirelessly received from the remote user device.

2. The apparatus of claim 1, further comprising a sensor configured to determine the fluid amount in the filter assembly.

3. The apparatus of claim 1, wherein the controller is configured for operation when a vehicle associated with the filter is in an engine off state.

4. The apparatus of claim 1, wherein the fluid amount corresponds to a water amount in the filter assembly.

5. The apparatus of claim 1, wherein the predetermined threshold value is in a range of a calibrateable floor to a calibrateable ceiling.

6. The apparatus of claim 1, wherein the filter state comprises a fault code corresponding to the filter assembly, and wherein the filter state is configured to indicate whether a filter drain is required based on the fault code.

7. The apparatus of claim 1, wherein a raised fault code is generated responsive to the fluid amount at least one of meeting or exceeding the predetermined threshold value.

8. The apparatus of claim 1, wherein a low fault code is generated responsive to the fluid amount not meeting the predetermined threshold value, and wherein the low fault code indicates a filter drain is not required.

9. The apparatus of claim 1, wherein the intelligent solenoid is configured to transmit information corresponding to the filter state to the remote user device.

10. The apparatus of claim 1, wherein the information provided to the remote user device includes an indication of whether a drain of the filter assembly is required.

11. A method for remotely draining a filter assembly, the method comprising:
connecting, via a network configured for wireless connectivity, to an intelligent solenoid coupled to a filter assembly;
receiving, from the intelligent solenoid, information corresponding to a filter state indicative of a fluid amount corresponding to the filter assembly; and
transmitting instructions so as to actuate the intelligent solenoid to thereby cause a release of fluid responsive to the filter state and the transmitted instructions.

12. The method of claim 11, wherein the network configured for wireless connectivity is operable via a wireless chip, wireless circuit, wireless communication network, or combinations thereof.

13. The method of claim 11, further comprising:
receiving an engine state;
determining whether a vehicle associated with the filter assembly is in an engine on state or an engine off state; and
generating a filter status notification when the vehicle associated with the filter assembly is in the engine on state or the engine off state based on the engine state received.

14. The method of claim 11, further comprising outputting, via a vehicle management interface, the filter state.

15. The method of claim 11, further comprising receiving, via a user selection of a link, an icon, a button, an audio selection, or combinations thereof, an indication configured to transmit instructions to the intelligent solenoid to thereby cause the release of the fluid responsive to the filter state corresponding to a required filter drain.

16. The method of claim 11, further comprising receiving, via a user selection of a link, an icon, a button, an audio selection, or combination thereof, an indication configured to transmit instructions to the intelligent solenoid to thereby cause the release of the fluid responsive to the filter state corresponding to an optional filter drain.

17. The method of claim 11, wherein the intelligent solenoid is configured to actuate a release coupled to the intelligent solenoid to thereby release the fluid.

18. The method of claim 11, further comprising:
receiving vehicle management history; and
outputting, via a vehicle management interface, the vehicle management history.

19. The method of claim 11, wherein the fluid amount corresponds to a water amount.

20. An apparatus comprising:
a remote user device, the remote user device configured to:
connect, via a network configured for wireless connectivity, to an intelligent solenoid coupled to a filter assembly;
receive, from the intelligent solenoid, information corresponding to a filter state indicative of a fluid amount corresponding to the filter assembly; and
transmit instructions so as to actuate the intelligent solenoid to thereby cause, via a vehicle management interface corresponding to the remote user device, a release of fluid responsive to the filter state and the transmitted instructions.

21. The apparatus of claim 20, wherein the network configured for wireless connectivity is operable via a wireless chip, wireless circuit, wireless communication network, or combination thereof.

22. The apparatus of claim 20, wherein the remote user device is configured to output, via the vehicle management interface, the filter state.

23. The apparatus of claim 20, wherein the remote user device is configured to receive, via a user selection of a link, an icon, a button, an audio selection, or combination thereof, an indication configured to transmit instructions to the intelligent solenoid to thereby cause the release of the fluid responsive to the filter state corresponding to a required filter drain.

24. The apparatus of claim 20, wherein the remote user device is configured to receive, via a user selection of a link, an icon, a button, an audio selection, or combination thereof, an indication configured to transmit instructions to the intelligent solenoid to thereby cause the release of the fluid responsive to the filter state corresponding to an optional filter drain.

25. The apparatus of claim 20, wherein the intelligent solenoid is configured to actuate a release coupled to the intelligent solenoid to thereby release the fluid.

26. The apparatus of claim 20, wherein the remote user device is further configured to
receive vehicle management history; and
output, via a vehicle management interface, the vehicle management history.

27. The apparatus of claim 20, wherein the vehicle management interface is configured for operation when a vehicle associated with the filter is in an engine off state.

28. The apparatus of claim 20, wherein the remote user device is configured to receive information corresponding to an engine state;
determine whether a vehicle associated with the filter assembly is in an engine on state or an engine off state; and
generate a filter status notification when the vehicle associated with the filter assembly is in the engine on state or the engine off state based on the engine state received.

29. The apparatus of claim 20, wherein the intelligent solenoid comprises a wireless circuit, and wherein the wireless circuit is energized via at least one of a control circuit, battery, or radio frequency circuit.

30. A system, comprising:
a filter;
an intelligent solenoid coupled to the filter;
a controller communicatively coupled to the intelligent solenoid, the controller configured to:
determine, via a filter management circuit, a filter state based, at least in part, on a determination of the fluid amount exceeding a predetermined threshold value; and
a remote user device configured for wireless operation with the intelligent solenoid, the remote user device configured to:
connect, via a network configured for wireless connectivity, to the intelligent solenoid coupled to the filter;
receive, from the intelligent solenoid, information corresponding to the filter state indicative of the fluid amount corresponding to the filter; and
transmit, to the intelligent solenoid, instructions so as to actuate the intelligent solenoid to thereby cause a release of fluid responsive to the filter state and the transmitted instructions.

31. The system of claim 30, wherein the controller is further configured to:
determine, via a filter management circuit, a predetermined threshold value corresponding to the filter;
determine, via the filter management circuit, whether the fluid amount in the filter exceeds the predetermined threshold value; and
provide, via the filter management circuit, information corresponding to the filter state to a remote user device.

32. The system of claim 30, further comprising a sensor configured to determine the fluid amount in the filter.

33. The system of claim 30, wherein the intelligent solenoid is configured to operate wirelessly via a wireless chip, wireless circuit, wireless communication network, or combinations thereof.

34. The system of claim 30, wherein the vehicle management interface is configured for operation when a vehicle associated with the filter is in an engine off state.

36. The system of claim 30, wherein the remote user device is configured to
receive information corresponding to an engine state;
determine whether a vehicle associated with the filter is in an engine on state or an engine off state; and
generate a filter status notification when the vehicle associated with the filter is in the engine on state or the engine off state based on the engine state received.

37. The system of claim 30, wherein the fluid amount corresponds to a water amount.

38. The system of claim 30, wherein the instructions transmitted by the remote user device are transmitted directly to the intelligent solenoid.

39. The system of claim 30, wherein the instructions transmitted by the remote user device to the controller, and in response to the transmitted instructions, the controller instructs the intelligent solenoid to cause the release of fluid responsive to the filter state.
